(19) United States
(12) Patent Application Publication
(10) Pub. No.: US 2023/0384275 A1
(43) Pub. Date: Nov. 30, 2023

(54) METHOD OF DESIGNING ADSORPTION COLUMNS

(71) Applicant: SABIC GLOBAL TECHNOLOGIES B.V., BERGEN OP ZOOM (NL)

(72) Inventor: Ashwin Ravi SANKAR, Bangalore (IN)

(73) Assignee: SABIC GLOBAL TECHNOLOGIES B.V., BERGEN OP ZOOM (NL)

(21) Appl. No.: 18/249,028

(22) PCT Filed: Oct. 15, 2021
(86) PCT No.: PCT/IB2021/059535

§ 371 Date: Apr. 13, 2023

Related U.S. Application Data
(60) Provisional application No. 63/093,054, filed on Oct. 16, 2020.

(51) Int. Cl. G01N 30/86

(52) U.S. Cl. CPC G01N 30/8693; G01N 30/8658

(57) ABSTRACT

A method of optimizing a design parameter for an adsorption column includes developing a first kinetic model and a Linear Driving Force model for a chromatography and ion exchange based adsorption process. Both analytical solutions to the first kinetic model and the Linear Driving Force model are then used to determine an optimal range of the design parameter.

### CROSS REFERENCE TO RELATED APPLICATIONS

This application claims the benefit of priority to U.S. Provisional Patent Application No. 63/093,054, filed Oct. 16, 2020, the entire contents of which are hereby incorporated by reference in their entirety.

### FIELD OF INVENTION

The present invention generally relates to adsorption based separation processes. More specifically, the present invention relates to methods of optimizing parameters for an adsorption column using more than one numerical models.

### BACKGROUND OF THE INVENTION

Separation of liquid mixtures is an important process in the chemical industry for purifying products and/or recovering unreacted materials. Conventionally, adsorption columns are often utilized in industrial treatment plants (e.g., chemical, petrochemical, environmental, etc.) to pull impurities or unwanted content from a source material or fluid.

Adsorption is the adhesion of atoms or molecules from one substance to the surface of another substance. An adsorption column typically includes a catalyst and/or a separation adsorbent material, which initiates or causes adsorption of the desired chemical, also known as adsorbate, to a surface thereof. Such catalyst and/or adsorbent material are referred to as packing of adsorption columns, and the packing is used to initiate or enhance the adsorption process. The packing may be loose and, in such cases, the packing may be positioned within a structure to hold the packing in place, which is often referred to as a “bed”.

Conventional adsorption processes, such as adsorption processes that employ adsorbents including activated carbon and ion exchange resins (cationic, anionic, aldehyde removal resins, etc.) are generally slow mass transfer processes. Such processes utilize frequent regeneration of adsorbent (e.g., resin) due to faster breakthrough times leading to shorter cycle times and lower adsorbent (e.g., resin) utilization. Such processes also may use large quantities of regeneration solvents and generate large amounts of wastewater, which leads to challenges in terms of operating cost, sustainability, and complying with environmental regulations.

Overall, while systems and methods for separating compounds using adsorption columns exist, the need for improvements in this field persists in light of at least the aforementioned drawbacks for the conventional methods.

### BRIEF SUMMARY OF THE INVENTION

A solution to at least some of the above-mentioned problems associated with adsorption column based separation process has been discovered. The solution resides in a method of determining an optimal range for a parameter of an adsorption column by using a Thomas kinetic model and a Linear Driving Force model. This can be beneficial for providing a more precise method of determining the parameters for the adsorption columns to achieve optimal adsorption efficiency compared to conventional methods that use empirical correlations to determine parameters for the adsorption columns. Furthermore, the disclosed method includes constructing and using an algorithm to determine optimal parameter ranges, thereby arriving at optimal adsorption column design faster than conventional methods. Additionally, the disclosed method uses analytical solutions to both Thomas kinetic model and the linear driving force model, thereby providing more complete and accurate solution. Moreover, the disclosed method is capable of providing design parameters for adsorption columns that are specifically optimized for each of a wide range of applications compared to conventional methods, which use universal design for all the applications of the adsorption column. Therefore, the method provides a technical solution to at least some of the problems associated with the conventional methods for designing and using adsorption columns for chemical separation.

Embodiments of the invention include a method of determining an optimal range for a parameter of an adsorption column. The method comprises deriving an analytical solution for a chromatography and ion exchange kinetic model of the adsorption column. The method comprises deriving an analytical solution for a Linear Driving Force model. Each of the analytical solutions includes a mathematical correlation between a concentration of an adsorbate in the adsorption column and a feed concentration of the adsorbate. The method comprises generating data of the concentration of the adsorbate in the adsorption column against values of a dimensionless number corresponding to the parameter based on each of the two analytical solutions. The method comprises determining the optimal range for the parameter based on the data generated by using both analytical solutions.

Embodiments of the invention include a method of obtaining an optimal range for a parameter of an adsorption column. The method comprises establishing a Thomas kinetic model for chromatography and ion exchange for the adsorption column. The method comprises establishing a Linear Driving Force model for the adsorption column. The method comprises deriving an analytical solution for the chromatography and ion exchange kinetic model including a Thomas kinetic model. The analytical solution for the Thomas kinetic model includes:

$$\frac{c}{{c}_{0}} = \frac{{I}_{0} ( 2 \sqrt{{A}_{1} {Bx}^{′} y} ) + ϕ ( α y , β {x}^{′} )}{{I}_{0} ( 2 \sqrt{{A}_{1} {Bx}^{′} y} ) + ϕ ( α y , β {x}^{′} ) + ϕ ( {Bx}^{′} , {A}_{1} y )} ;$$

where A₁=k_{d}/Q, where k_{d} is a desorption coefficient of the adsorbate on an adsorbent of the adsorption column and Q is a volumetric flowrate of a solution containing the adsorbate; B=kₐqₘ/Q, kₐ is the adsorption coefficient of the adsorbate on the adsorbent in the adsorption column, qₘ is concentration of the adsorbate per unit mass of the adsorbent; x′ is mass of the adsorbent at any distance from an inlet of the adsorption column, y=Qt−mx′, t is a time point, at which concentration of the adsorbate in the adsorption column is c, m is free space per mass of the adsorbent (ml/mg),

$$α = \frac{{K}_{a} {C}_{0} + {K}_{d}}{Q} ; β = \frac{{K}_{a} {K}_{d} {q}_{m}}{{K}_{a} {C}_{0} + {K}_{d}} * \frac{1}{Q} ; \\ ϕ ( {x}^{′} , y ) = {I}_{0} ( 2 \sqrt{{A}_{1} {Bx}^{′} y} ) + \tilde{ϕ} ( {Bx}^{′} , {A}_{1} y ) + \tilde{ϕ} ( α y , β {x}^{′} ) ; \\ \tilde{ϕ} ( x , y ) = {e}^{x} {\int }_{0}^{x} {e}^{- t} {I}_{0} ( 2 \sqrt{yt} ) dt ; {I}_{0} ( x ) = 1 + \frac{{x}^{2}}{{2}^{2}} + \frac{{x}^{4}}{{2}^{2} {4}^{2}} + … ;$$

x is a hydrodynamic entrance length for the solution containing the adsorbate in the adsorption column. The method comprises deriving an analytical solution for the Linear Driving Force model, wherein the analytical solution for the Linear Driving Force model includes:

$$\frac{c}{{c}_{0}} = \frac{1}{2} + A [ \frac{15 ∈ ( t - θ )}{2 \sqrt{N}} ] ,$$

where c is a concentration of an adsorbate in the adsorption column; c₀ is an initial concentration of the adsorbate; A is the area of normal curve of error; t is a time point at which the concentration of the adsorbate in the adsorption column is c, θ is the time at a point of inflection in a breakthrough curve; N is a number of theoretical equivalent plates of the adsorbent column; [symbol] =D/r², where D is a diffusion coefficient of the adsorbate in spherical particles; r is particle radius for the spherical particles. The method comprises generating data of the concentration of the adsorbate in the adsorption column against values of a dimensionless number corresponding to the parameter using each of the two analytic solutions. The method comprises determining the optimal range for the parameter based on the data generated by using both analytical solutions.

Embodiments of the invention include a method of obtaining an optimal range for a length to diameter ratio of an adsorption column. The method comprises establishing a Thomas kinetic model for chromatography and ion exchange for the adsorption column. The method includes establishing a Linear Driving Force model for the adsorption column. The method includes deriving an analytical solution for the chromatography and ion exchange kinetic model including a Thomas kinetic model. The analytical solution for the Thomas kinetic model, includes:

$$\frac{c}{{c}_{0}} = \frac{{I}_{0} ( 2 \sqrt{{A}_{1} {Bx}^{′} y} ) + ϕ ( α y , β {x}^{′} )}{{I}_{0} ( 2 \sqrt{{A}_{1} {Bx}^{′} y} ) + ϕ ( α y , β {x}^{′} ) + ϕ ( {Bx}^{′} , {A}_{1} y )} ;$$

where A₁=k_{d}/Q, where k_{d} is a desorption coefficient of the adsorbate on an adsorbent of the adsorption column and Q is a volumetric flowrate of a solution containing the adsorbate; B=kₐqₘ/Q, kₐ is the adsorption coefficient of the adsorbate on the adsorbent in the adsorption column, qₘ is concentration of adsorbate per unit mass of the adsorbent; x′ is mass of the adsorbent at any distance from an inlet of the adsorption column, y=Qt−mx′, t is a time point, at which the concentration of the adsorbate in the adsorption column is c, m is free space per mass of the adsorbent (ml/mg),

$$α = \frac{{K}_{a} {C}_{0} + {K}_{d}}{Q} ; β = \frac{{K}_{a} {K}_{d} {q}_{m}}{{K}_{a} {C}_{0} + {K}_{d}} * \frac{1}{Q} ; \\ ϕ ( {x}^{′} , y ) = {I}_{0} ( 2 \sqrt{{A}_{1} {Bx}^{′} y} ) + \tilde{ϕ} ( {Bx}^{′} , {A}_{1} y ) + \tilde{ϕ} ( α y , β {x}^{′} ) ; \\ \tilde{ϕ} ( x , y ) = {e}^{x} {\int }_{0}^{x} {e}^{- t} {I}_{0} ( 2 \sqrt{yt} ) dt ; {I}_{0} ( x ) = 1 + \frac{{x}^{2}}{{2}^{2}} + \frac{{x}^{4}}{{2}^{2} {4}^{2}} + … ;$$

x is a hydrodynamic entrance length for the solution containing the adsorbate in the adsorption column. The method includes deriving an analytical solution for linear driving force model. The analytical solution for linear driving force model includes:

$$\frac{c}{{c}_{0}} = \frac{1}{2} + A [ \frac{15 ∈ ( t - θ )}{2 \sqrt{N}} ] ,$$

where c is the a concentration of an adsorbate in the adsorption column; c₀ is an outlet concentration of the adsorbate; A is the area of normal curve of error; t is a time point, at which the concentration of the adsorbate in the adsorption column is c, θ is a time at the point of inflection in a breakthrough curve; N is a number of theoretical equivalent plates of the adsorbent column; [symbol] =D/r², where D is a diffusion coefficient of the adsorbate in spherical particles; r is particle radius of the spherical particles. The method comprises generating data of the concentration of the adsorbate in the adsorption column against values of the length to diameter ratio using each of the two analytical solutions. The method comprises determining the optimal range for the length to diameter ratio by selecting a range of the length to diameter ratio, in which the data generated based on both analytical solutions show substantially the same trend and an adsorption efficiency related variable reaches a global maximum and/or minimum value(s).

The following includes definitions of various terms and phrases used throughout this specification.

The terms “about” or “approximately” are defined as being close to as understood by one of ordinary skill in the art. In one non-limiting embodiment the terms are defined to be within 10%, preferably, within 5%, more preferably, within 1%, and most preferably, within 0.5%.

The terms “wt. %”, “vol. %” or “mol. %” refer to a weight, volume, or molar percentage of a component, respectively, based on the total weight, the total volume, or the total moles of material that includes the component. In a non-limiting example, 10 moles of component in 100 moles of the material is 10 mol. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification, include any measurable decrease or complete inhibition to achieve a desired result.

The term “effective,” as that term is used in the specification and/or claims, means adequate to accomplish a desired, expected, or intended result.

The term “breakthrough curve” as that term is used in the specification and/or claims, means a plot between outlet concentration versus time. The time at which the outlet concentration becomes equal to the inlet concentration of the feed, indicating the bed fully is saturated at this point, which is breakthrough time of an adsorption column. The point of inflection is the point on a continuous plane breakthrough curve at which the curve changes from being concave (concave downward) to convex (concave upward), or vice versa

The use of the words “a” or “an” when used in conjunction with the term “comprising,” “including,” “containing,” or “having” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The process of the present invention can “comprise,” “consist essentially of,” or “consist of” particular ingredients, components, compositions, etc., disclosed throughout the specification.

The term “primarily,” as that term is used in the specification and/or claims, means greater than any of 50 wt. %, 50 mol. %, and 50 vol. %. For example, “primarily” may include 50.1 wt. % to 100 wt. % and all values and ranges there between, 50.1 mol. % to 100 mol. % and all values and ranges there between, or 50.1 vol. % to 100 vol. % and all values and ranges there between.

The term “entry length,” as that term is used in the specification and/or claims, means the distance the fluid needs to travel to achieve a fully developed flow regime. This headspace is provided in the top part of adsorption columns.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

For a more complete understanding, reference is now made to the following descriptions taken in conjunction with the accompanying drawings, in which:

FIG. 1 shows a schematic flowchart for a method of obtaining an optimal range for a parameter of an adsorption column, according to embodiments of the invention;

FIG. 2 shows a breakthrough curve of an activated carbon adsorbent for a batch mixing urea adsorption process; and

FIG. 3 shows a breakthrough curve of an adsorption column with optimized length to diameter ratio for urea adsorption processes.

### DETAILED DESCRIPTION OF THE INVENTION

Currently, adsorption based separation processes suffer several drawbacks including low adsorption efficiency, short adsorbent life span, need for frequent regeneration, and negative environmental impact. The present invention provides a solution to at least some of these problems associated with adsorption column based separation processes. The solution is premised on a method of determining an optimal range for a parameter of an adsorption column, including length to diameter ratio, to achieve optimized adsorption efficiency, reduce adsorbent regeneration frequency, and/or mitigating environmental impact of the adsorption process. Additionally, the disclosed method uses numerical models to obtain the optimal range for the parameter of the adsorption column. This can be beneficial for obtaining the optimal ranges designed specifically for each of a wide variety of applications in a short period of time. Moreover, the disclosed method is based on analytical solutions of two fluid dynamic models, thereby obtaining more accurate results than conventional methods. These and other non-limiting aspects of the present invention are discussed in further detail in the following sections.

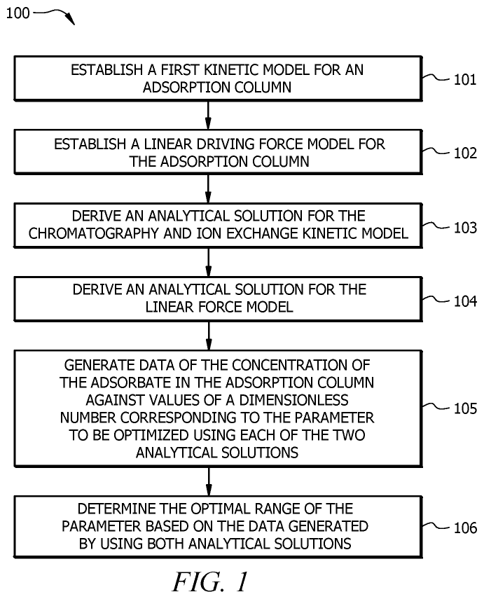

In embodiments of the invention, the method of determining and/or obtaining an optimal range for a parameter of an adsorption column to mitigate problems associated with adsorption column based separation processes is disclosed. With reference to FIG. 1, a schematic flowchart is shown for method 100 that is capable of obtaining optimal range for one or more adsorption column design parameters using at least two numerical models. Non-limiting examples for adsorption column design parameters can include a length of the adsorption column, a diameter of the adsorption column, a ratio of length to diameter of the adsorption column, an entry length of the adsorption column, adsorbate axial distribution of the adsorption column, a flow direction for the adsorption column, wavefront development through estimation of Schmidt number and/or axial Peclet number, or combinations thereof.

In embodiments of the invention, the adsorption column is configured to adsorb an impurity or an adsorbate (impurity or impurities) comprising a fluoride, urea, an aldehyde, glycolic acid, acidic acid, a base including sodium hydroxide and sodium acetate, a polymeric compound, a cation, an anion, or combinations thereof. Exemplary aldehydes can include formaldehyde, and/or acetaldehyde. Exemplary cations can include Al³⁺, Ca²⁺, and Na⁺. Exemplary anion can include PO₄³⁻, SO₄²⁻, Cl⁻, and Br⁻. The adsorption column can include an adsorbent including activated carbon, activated alumina, silica gel, a zeolite, a polymer, a resin, or combinations thereof. Exemplary resins for the adsorbent can include an anionic strongly and/or weakly basic resin, a cationic strongly and/or weakly acidic resin, a specialized ion-exchange resin, or combinations thereof. In embodiments of the invention, strongly and/or weakly basic ion exchange resins can include quaternary amino groups including trimethylammonium groups, and/or polyethylene amine. Strongly and/weakly acidic ion exchange resin can include a carboxylic acid group, and/or a sulfonic acid group including sodium polystyrene sulfonate or poly AMPS. The specialized ion-exchange resin can include a chelating resin including an iminodiacetic acid or a thiourea-based resin.

According to embodiments of the invention, as shown in block 101, method 100 includes establishing a first kinetic model for an adsorption column. In embodiments of the invention, the adsorption column is used for chromatography and/or ion exchange based separation processes. The first kinetic model may include a Thomas kinetic model. In embodiments of the invention, the establishing at block 101 includes deriving equations of conservation for chromatography for adsorbing an impurity from a solution. In embodiments of the invention, a conservation equation for the Thomas kinetic model includes

$$\frac{\partial q}{\partial t} + m \frac{\partial c}{\partial t} + \dot{Q} \frac{\partial c}{\partial {x}^{′}} = 0 ( 1 ) , \qquad ( 1 )$$

with conditions of x′=A₁x(1−∈_{b})ρₚ, which is equal to mass of an adsorbent of the adsorption column from any distance from the inlet end; wherein ∈_{b} is porosity of adsorbent bed; t is time (minute); c is a target outlet concentration of an impurity in a solution (mmol/ml) (e.g., anion/cation/aldehyde impurities in cycle water outlet stream; q is a concentration (mmol/g) of the amount of impurities and/or species (e.g., aldehyde) adsorbed in the adsorbent (e.g., aldehyde removal resin); m is free space per mass of the adsorbent (ml/mg), A₁=kₐ/Q, where kₐ is desorption coefficient and Q is the volumetric flow rate of solution. The establishing can further include changing equation (1) in terms of independent variables including x′=x′=the mass of the adsorbent upstream, y=Qt−mx′=volume of the solution downstream. The establishing of the Thomas kinetic model at block 101 further still includes using the conditions to obtain transformed conservation equation of

$$\frac{\partial c}{\partial {x}^{′}} + \frac{\partial q}{\partial y} = 0 ( 2 ) . \qquad ( 2 )$$

In embodiments of invention, the establishing at block 101 further includes deriving a Langmuir Kinetics based equation for adsorption including

$$\dot{R} = \frac{\partial q}{\partial t} = {k}_{a} c ( {q}_{m} - q ) - {k}_{d} q , \qquad ( 3 )$$

wherein \dot{R} is the rate of dynamic change of adsorbed material in the adsorbent, qₘ is concentration of adsorbed species per unit mass of adsorbent, kₐ is an adsorption coefficient of the adsorbate to the adsorbent, k_{d} is a desorption coefficient of the adsorbate from the adsorbent, t is the time at which the exit concentration is c. The establishing at block 101 may further include deriving equation (4) based on equation (2), where equation (4) is

$$c = \frac{\partial F}{\partial y} ; q = - \frac{\partial F}{\partial {x}^{′}} . \qquad ( 4 )$$

Establishing at block 101 may further still include deriving equation (5) based on equations (2) to (4), where equation (5) is

$$\frac{{\partial }^{2} F}{\partial {x}^{′} \partial y} + {A}_{1} \frac{\partial F}{\partial {x}^{′}} + B \frac{\partial F}{\partial y} + \hat{C} \frac{\partial F}{\partial {x}^{′}} \frac{\partial F}{\partial y} = 0 , \\ where {A}_{1} = \frac{{K}_{d}}{\dot{Q}} , B = \frac{{K}_{d} {q}_{m}}{\dot{Q}} , \hat{C} = \frac{{K}_{a}}{\dot{Q}} . \qquad ( 5 )$$

Boundary conditions for equation (5) may include

$$\begin{matrix}{x}^{′} = 0 , y \geq 0 , c = {c}_{o} \\ {x}^{′} > 0 , y = 0 , q = 0\end{matrix} .$$

In embodiments of the invention, equation (5) is further validated using experimental data. In embodiments of the invention, values of kₐ and k_{d} are estimated.

According to embodiments of the invention, as shown in block 102, method 100 includes establishing a Linear Driving Force model for the adsorption column. In embodiments of the invention, the establishing at block 102 includes deriving one or more empirical diffusion equations under the conditions of the mean internal concentration change dq̅/dt as a function of mean internal concentration q̅ and surface concentration q, where internal concentration means concentration of adsorbate on inside the adsorbent, and surface concentration means concentration of adsorbate on the surface of the adsorbent. In embodiments of the invention, establishing at block 102 further includes developing mass balance equation of adsorbate by neglecting secondary effects other than non-equilibrium caused by adsorbent particle diffusion. The mass balance equation for the adsorbate can include

$${( \frac{\partial {q}^{*}}{\partial v} )}_{x} + {( \frac{α \partial c}{\partial v} )}_{x} + {( \frac{\partial c}{\partial x} )}_{v} = 0 , \qquad ( 6 )$$

where c is the concentration of the adsorbate in the liquid phase outside of adsorbent particles, v is the amount of solution passed, x is the column volume measured from the top, q* is the solute adsorbed per unit volume of the column, a is the pore fraction in the adsorption column.

In embodiments of the invention, establishing at block 102 includes deriving diffusion equation of

$$\frac{\partial \overline{q}}{\partial t} = ψ ( \overline{q} , q ) , \qquad ( 7 )$$

and adsorption isotherm correlation on adsorption surface of q*=f*(c) or q*+αc=f(c), where v and t are related by

$$\frac{v}{F} = t ,$$

wherein F is volumetric flow of liquid mixture to be separated, f(c) is the amount of adsorbate adsorbed in a unit volume of the adsorption column when in equilibrium with the solution of concentration c. Establishing at block 102 may further include replacing q* using equations (5) and (6) to obtain equation (8) as

$$\frac{{dq}^{*}}{d ε t} = 15 ( {f}^{*} ( c ) - {q}^{*} ) ,$$

where A [z] is the area of normal curve of error for

$$z = \frac{1}{\sqrt{2 n}} {\int }_{0}^{x = z} exp ( - \frac{{x}^{2}}{2} dx ) , a = {K}_{d} + α ,$$

where α is void fraction in the column, q*=q̅(1−α) is the amount of adsorbate adsorbed per unit volume of the adsorption column.

According to embodiments of the invention, as shown in block 103, method 100 includes deriving an analytical solution for the chromatography and ion exchange kinetic model. In embodiments of the invention, the chromatography and ion exchange kinetic model can include a Thomas kinetic model, and the analytical solution for the Thomas kinetic model includes

$$\frac{c}{{c}_{0}} = \frac{{I}_{0} ( 2 \sqrt{{A}_{1} {Bx}^{′} y} ) + ϕ ( α y , β {x}^{′} )}{{I}_{0} ( 2 \sqrt{{A}_{1} {Bx}^{′} y} + ϕ ( α y , β {x}^{′} ) + ϕ ( {Bx}^{′} , {A}_{1} y )} ; \qquad ( 9 )$$

where A₁=k_{d}/Q where k_{d} is a desorption coefficient of the adsorbate on an adsorbent of the adsorption column and Q is a volumetric flowrate of a solution containing the adsorbate; B=kₐqₘ/Q, kₐ is the adsorption coefficient of the adsorbate on the adsorbent in the adsorption column, qₘ is concentration of adsorbed adsorbate per unit mass of adsorbent; x′ is mass of the adsorbent at any distance from an inlet of the adsorption column, y=Qt−mx′, t is a time point, at which concentration of the adsorbate in the adsorption column is c, m is free space per mass of the adsorbent (ml/mg),

$$α = \frac{{K}_{a} {C}_{0} + {K}_{d}}{Q} ; β = \frac{{K}_{a} {K}_{d} {q}_{m}}{{K}_{a} {C}_{0} + {K}_{d}} * \frac{1}{Q} ;$$

$$ϕ ( {x}^{′} , y ) = {I}_{0} ( 2 \sqrt{{A}_{1} {Bx}^{′} y} ) + \tilde{ϕ} ( {Bx}^{′} , {A}_{1} y ) + \tilde{ϕ} ( α y , β {x}^{′} )$$

$$\tilde{ϕ} ( x , y ) = {e}^{x} {\int }_{0}^{x} {e}^{- t} {I}_{0} ( 2 \sqrt{yt} ) dt ; {I}_{0} ( x ) = 1 + \frac{{x}^{2}}{{2}^{2}} + \frac{{x}^{4}}{{2}^{2} {4}^{2}} + …$$

x is a hydrodynamic entrance length for the solution containing the adsorbate (impurity or impurities) in the adsorption column. In embodiments of the invention, the analytical solution of the Thomas kinetic model is derived via a software platform. Exemplary software platforms can include Berkeley Madonna, Matlab, Aspen, and JMP.

According to embodiments of the invention, as shown in block 104, method 100 includes deriving an analytical solution for the Linear Driving Force model. The analytical solution for the Linear Driving Force model includes:

$$\frac{c}{{c}_{0}} = \frac{1}{2} + A [ \frac{15 ∈ ( t - θ )}{2 \sqrt{N}} ] ,$$

where c is a concentration of an adsorbate in the adsorption column; c₀ is an initial concentration of the adsorbate; A is the area of normal curve of error; t is a time point at which the concentration of the adsorbate in the adsorption column is c, θ is the time at a point of inflection in a breakthrough curve; N is a number of theoretical equivalent plates of the adsorbent column; ∈=D/r², where D is a diffusion coefficient of the adsorbate in adsorbent particles; r is particle radius or characteristic length for the adsorbent particles. In embodiments of the invention, the analytical solution of the Linear Driving Force model is derived via a software platform. Exemplary software platform for deriving solution for Linear Driving Force model can include Berkeley Madonna, Matlab, GAMS (General Algebraic Modeling System Software), JMP, and ACM (Aspen Custom Modeler).

According to embodiments of the invention, as shown in block 105, method 100 includes generating data of the concentration of the adsorbate in the adsorption column against values of a dimensionless number corresponding to the parameter to be optimized, using each of the two analytical solutions. In embodiments of the invention, the data are generated using simulation and/or experimental results. The dimensionless number corresponding to the parameter to be optimized can include a length to diameter ratio, Biot number, Bodenstein number, Dean number, Prandtl number, Cavitation number, Bond number, Grashof number, Colburn factors, or combinations thereof. In embodiments of the invention, dimensionless numbers including Peclet number and Schmidt number are calculated for each c/c₀ value, and another dimensionless number including a dispersion number, which shows a relative value of mixing and efficiency of contact between adsorbent and adsorbate species to be adsorbed that can be calculated with another in-built model in parallel using correlation between Peclet number, adsorbent particle size and fluid velocity in the adsorption column. Dispersion number may represent the ratio of transport by diffusion to transport by convection. Efficiency of contact can refer to efficiency and/or increased probability that an adsorbate will come in contact with the adsorbent. In embodiments of the invention, the mass transfer rates and consequently separation efficiency increase with increase of contact efficiency. The in-built model can include Peclet/dispersion number with axial dispersion correlations. The in-built model calculates the ratio of axial to radial dispersion along with reaction/adsorption kinetics correlating to Zel'dovich number (optional). This helps with faster estimations of optimal L/d (length to diameter) ratio.

According to embodiments of the invention, as shown in block 106, method 100 includes determining the optimal range of the parameter based on the data generated by using both analytical solutions. In embodiments of the invention, the optimal range of the parameter is determined where the data generated based on both analytical solutions show substantially the same trend and an adsorption related variable reaches a global maximum and/or minimum value. In embodiments of the invention, the adsorption efficiency related variable comprises adsorption capacity, time of breakthrough, residence time distribution, channeling effect parameters, or combinations thereof. In embodiments of the invention, the determining step at block 106 can include conducting multiple iterations by varying input parameters in the analytical solutions to the Thomas kinetic model and the linear driving force model. In embodiments of the invention, exemplary input parameters can include volumetric/mass flow rate of feed containing adsorbate, concentration at feed inlet of adsorbate, Adsorbent properties including: theoretical capacity in terms of mEq/L (miliequivalents per liter), PSD (particle-size distribution), average diameter/radius, surface area of adsorbent, Target exit adsorbate concentration, initial guess value of diffusivity, void fraction/packing density of adsorbent bed, time of run, or combinations thereof. The determining step at block 106 can further include obtaining a maximum and/or a minimum value of the adsorption efficiency related variable in a range of the parameter to be optimized. The determining step at block 106 can further include selecting the range for the parameter to be optimized corresponding to the maximum and/or minimum values of adsorption efficiency related variable. In embodiments of the invention, maximum value is selected for adsorption efficiency related variables including adsorption capacity, and/or breakthrough time. Minimum value is selected for adsorption efficiency related variables including pressure drop in the adsorption column, and/or channeling of the adsorption column.

In embodiments of the invention, experimental data is used to validate the model initially for specific conditions (such as initial feed concentration, and flow rate etc.). Further with multiple iterations, experimental and/or combinations with simulation can be used. Optimal parameter such as L/D (length to diameter ratio) can be determined using multiple iterations where the point of convergence reaches a global maxima/minima.

According to embodiments of invention, method 100 overall includes developing analytical solutions are developed for both Linear Driving force model (Glueckauf) & Kinetic approach (Thomas model). This can be superior to any Numerical approach as it's less rigorous and depends on initial guess values and step function/parameters which needs to be pre-defined. Method 100 can include using both these solutions to predict outlet concentrations for a given dynamic feed concentration, which can be generated corresponding to the change in the concentration along the characteristic length of the column. This can be further plotted with the longitudinal and radial directions in 3D which gives “the parameters” desired for the specific case. Method 100, according to embodiments of the invention can further include using model prediction with both Thomas and Glueckauf model to obtain the solution/point of minima/maxima for “the parameters” i.e.; Length, Diameter, Aspect ratio, flow directionality, entry length, wave shape and desired axial distribution requirements specific to an application. The trend/pattern for each parameter can be studied/plotted using a corresponding DN (Dimensionless Number) by fitting each model. The area of the plot/data wherein the fitting shows same trend for both models and reaches a global maxima/minima can be further taken as the most optimal fit/parameter for the specific application. The gap/range of this convergence which is common between the models in the fit can be taken as the range for the particular adsorption/chromatographic application.

In embodiments of the invention, by implementing method 100, an optimal length to diameter ratio for an adsorption column with activated carbon adsorbent used in adsorbing urea from a mixture of water and ionic impurities is in a range of 3.2 to 6.5 and all ranges and values there between including ranges of 3.2 to 3.5, 3.5 to 3.8, 3.8 to 4.1, 4.1 to 4.4, 4.4 to 4.7, 4.7 to 5.0, 5.0 to 5.3, 5.3 to 5.6, 5.6 to 5.9, 5.9 to 6.2, and 6.2 to 6.5. In embodiments of the invention, an optimal length to diameter ratio for an adsorption column with activated carbon adsorbent used in adsorbing urea from a mixture of water and ionic impurities is preferably about 4.7.

In embodiments of the invention, by implementing method 100, an optimal length to diameter ratio for an adsorption column with an ion-exchange resin as the adsorbent used in adsorbing an aldehyde from a mixture of monoethylene glycol, water, and/or other ionic impurities is in a range of 2.2 to 5.5 and all ranges and values there between including ranges of 2.2 to 2.5, 2.5 to 2.8, 2.8 to 3.1, 3.1 to 3.4, 3.4 to 3.7, 3.7 to 4.0, 4.0 to 4.3, 4.3 to 4.6, 4.6 to 4.9, 4.9 to 5.2, and 5.2 to 5.5. In embodiments of the invention, an optimal length to diameter ratio for an adsorption column with an ion-exchange resin as the adsorbent used in adsorbing an aldehyde from a mixture of monoethylene glycol, water, and/or other ionic impurities is preferably about 4.1.

As part of the disclosure of the present invention, specific examples are included below. The examples are for illustrative purposes only and are not intended to limit the invention. Those of ordinary skill in the art will readily recognize parameters that can be changed or modified to yield essentially the same results.

### Example 1

### Adsorption of Urea Using an Adsorption Column with Optimal L/D Ratio

Adsorption of urea using an adsorption column from a dialysate buffer was conducted. In this experiment, a glass column was packed with activated carbon while maintaining L/D ratio as 5 in all the experiments. Packed column was wetted with distilled water for 24 hours before carrying out the urea adsorption experiments. Dialysate fluid composition having a urea concentration of 2000 ppm was poured from the top and passed through the column while applying a constant vacuum of 0.08 MPa at the bottom. The flowrate was observed as 1.5 ml/minute under employed experimental conditions. Aliquots were collected at different time interval over the period of 90-180 minutes and urea concentration was estimated.

Adsorption of urea with activated carbon as the adsorbent in batch conditions was conducted as a control. In the control experiment, a conical flask was charged with dialysate buffer loaded with 10 wt. % activated carbon and put on a shaker at 150 rpm at room temperature. After 24 hours, an aliquot was taken out from the solution, filtered and used for urea content analysis.

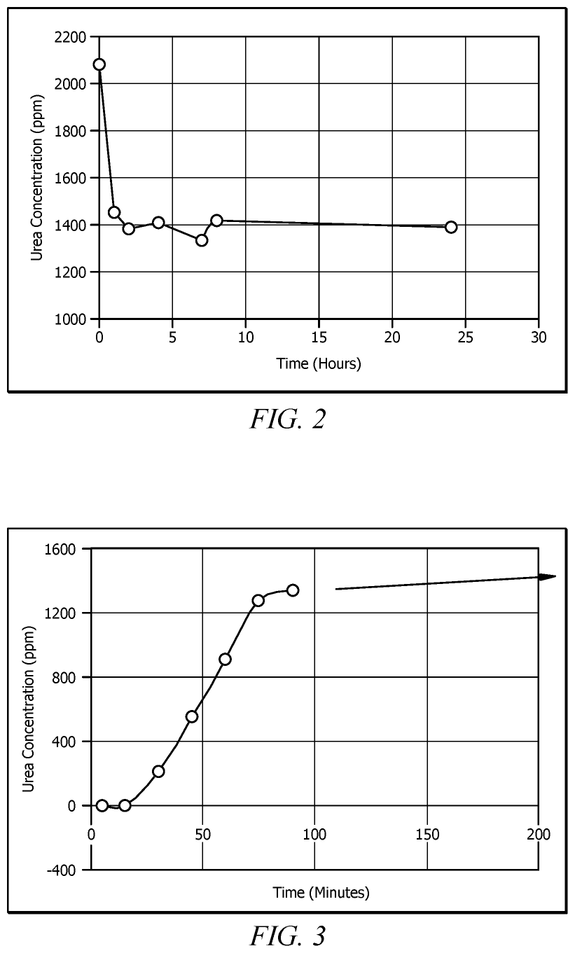

The activated carbon used in the experiments had a surface area of 1900 m²/g, and a pore size of 15-39 nm (majority of the pores have sizes in this range), and a particle size of 5 nm to 120 nm. The results are shown in FIGS. 2 and 3 and tables 1 and 2. The results show that urea adsorption capacity of the adsorption column with an optimized L/D ratio with activated carbon adsorbent is significantly higher than conventional batch mixing process (the control). The calculated urea adsorption capacity shown in Table 3 further indicates that the adsorption column with an optimized L/D ratio has more than 3 times of the urea adsorption capacity than batch mixing process (the control). In both experiments, the urea adsorption capacity was calculated using breakthrough curves. More specifically, trapezoidal rule was used to calculate the area under the curve and normalize methods of differences was used to project the break-through curve till break through point to calculate overall adsorption capacity.

TABLE 1
Results of batch experiment (control) for urea adsorption

| Time (Hr) | Urea Conc. (ppm) |
|---|---|
| 0 | 2080.7 |
| 1 | 1453.1 |
| 2 | 1384.4 |
| 4 | 1408.1 |
| 7 | 1332.4 |
| 8 | 1415.2 |
| 24 | 1389.2 |

TABLE 2
Results of urea adsorption using an adsorption
column with an L/D ratio of 4.8

| | L/D = 4.8 |
|---|---|
| Time (minutes) | Conc. (ppm) |
| 0 | 2077.12 (Stock Solution) |
| 5 | 0 |
| 15 | 0 |
| 30 | 209.528 |
| 45 | 553.76 |
| 60 | 905.299 |
| 75 | 1275.52 |
| 90 | 1335.995 |

TABLE 3
Calculated Adsorption capacity

| | | Urea Adsorption |
|---|---|---|
| S. No. | Adsorption process | capacity (g/kg) |
| 1 | Batch | 6.44 |
| 2 | Column (L/D): 4.8 | 22 |

### Example 2

### Comparison of Aldehyde Adsorption Efficiency

Experiments on aldehyde removal from triethylene glycol (TEG) samples with adsorption columns that have a length to diameter ratios of 1.2 and 4.1 were conducted. The adsorbent used in the adsorption columns was an ion-exchange resin (Purolite® C-160H). The results are shown in Table 4. The results indicate that the aldehyde adsorption efficiency was 11.6% higher when the L/d ratio of the column is 4.1 compared to when an L/D ratio was about 1.2, which represents the L/d ratio of a commercial adsorption column.

TABLE 4
Results for Aldehyde Removal from TEG using
Purolite ® C-160H adsorbent

| | L/D of 1.2 | L/D of 4.1 |
|---|---|---|
| Feed Aldehyde Concentration (ppm) | 400 | 400 |
| Time (minutes) | 20 | 20 |
| Concentration (ppm) | 224.6 | 178.2 |
| Aldehyde removal efficiency | 43.9% | 55.5% |

### Examples 3-5

Further experiments were conducted to determine the effect of L/D ratio on the adsorption of acetic acid, formaldehyde and acetate from aqueous solutions. The following protocol was used for each experiment:

A column either a metal or Glass column of suitable diameter is loaded with 800 grams of the resin identified in the tables below. Once the target L/D ratio was obtained with the packing of the resin, the column was soaked for 24 hours with stock/feed solution with the corresponding concentration:
500 ppm Acetic Acid
700 ppm Formladehyde
750 ppm of Sodium Acetate

The solutions were prepared with demineralized water and the requisite amount of the subject component to be tested.

After 24 hours, the solution was drained and fresh feed solution was introduced from the top of the column and is withdrawn from the bottom in a continuous manner. The flow rate used for each experiment is 4 times the bed volume per hour: namely; 30 L/hour for the acetic acid experiment, and 32 L/hour for the aldehyde and sodium acetate experiments.

An outlet sample is withdrawn every hour, and the concentration of each of the subject ions or aldehyde for each experiment is measured using ICP-titration technique [ion chromatography (IC) to inductively coupled plasma mass spectrometry (ICP/MS) and a breakthrough curve is plotted as Outlet concentration vs time.

Removal Efficiency is calculated from the AUC (Area under the Curve) of the Adsorption Breakthrough curve until the breakthrough time (the time which the inlet and outlet concentrations become equal.

TABLE 5
Column and Resin Details/Properties for experiments 3 to 5
Column and Resin Details/Properties

| Experiment No. | 3 | 4 | 5 |
|---|---|---|---|
| Parameter | Anion Removal | Aldehyde | Cationic |
| | Resin | Removal | Removal |
| | | Resin | Resin |
| Impurity | Acetic Acid | Formaldehyde | Sodium |
| (Normalized | | | Acetate |
| Quantification) | | | |
| Resin Name | Amberlyst | ARR-1 wet | Amberlyst 15 |
| | A-21 | bisulfite | |
| Resin Volume | 0.0075 (m³) | 0.008 (m³) | 0.008 (m³) |
| (m³) | | | |
| Particle Size | 0.4-1.19 mm | 0.3-1.2 mm | 20-50 mesh |
| (mm) | | | (0.297-0.841 mm) |
| Regenerant | 20 wt % NaOH | 25 wt % NaHSO3 | 32 wt. HCl |

Results of experiments 3 to 5 are shown in Tables 6-8 below:

TABLE 6
Acetic Acid Results (Exp. 3)

| Parameter | L/D of 1.1 | L/D of 3.5 | L/D of 4.2 |
|---|---|---|---|
| Feed Acetic Acid Concentration | 500 | 500 | 500 |
| (ppm) | | | |
| Breakthrough Time (min) | 474 | 385 | 258 |
| Cumulative Outlet Concentration | 264 | 229 | 171.2 |
| (ppm) | | | |
| Removal Efficiency (%) | 47.21% | 54.18% | 65.76% |

TABLE 7
Acetic Acid Results (Exp. 4)

| Parameter | L/D of 1.1 | L/D of 4.5 | L/D of 7.3 |
|---|---|---|---|
| Feed Aldehyde Concentration | 700 | 700 | 700 |
| (ppm) | | | |
| Breakthrough Time (min) | 768 | 398 | 546 |
| Cumulative Outlet Concentration | 472 | 281.2 | 281.2 |
| (ppm) | | | |
| Removal Efficiency (%) | 32.57% | 59.83% | 42.14% |

TABLE 8
Acetic Acid Results (Exp. 5)

| Parameter | L/D of 1.1 | L/D of 3.5 | L/D of 4.3 | L/D of 5.5 |
|---|---|---|---|---|
| Feed Sodium Acetate | 750 | 750 | 750 | 750 |
| Concentration (ppm) | | | | |
| Breakthrough Time (min) | 421 | 398 | 211 | 405 |
| Cumulative Outlet | 485.3 | 301.2 | 234.1 | 433.6 |
| Concentration (ppm) | | | | |
| Removal Efficiency (%) | 35.3% | 59.83% | 68.78% | 42.18% |

The effect of the L/D ratio on the removal efficiency can easily be determined from the results in Tables 6-8 above.

Regeneration of the resin beds of Experiments 3 to 5 was conducted done with the corresponding concentration of regenerant presented using a back-wash procedure. The bed is regenerated in 3 steps:
Step 1: about 30 L/hour flow rate-top to bottom using demineralized water, followed by
Step 2: regenerant-upflow 10-15 L/hour flowrate followed by
Step 3: another cycle of top to bottom flow of demineralized water at a rate of 30 L/hour

Similar to the Removal Efficiency; regeneration efficiency correspondingly improve when the L/D ratio corresponds to the optimal value for target application using corresponding resin (4.2 for acetic acid of Experiment 3, 4.5 for the aldehyde of Experiment 4 and 4.3 for the anion removal resin for sodium acetate of Experiment 5). The data presented below are for the regeneration of the aldehyde Removal Resin (ARR-1, wet bisulfite) using 25 wt % Sodium Bisulphite NaHSO₃ as regenerant (Table 9) and for regeneration of the cationic removal resin using 32 wt. % HCl as regenerant:

TABLE 9
Parameters for regeneration of aldehyde removal
resin using 25 wt % Sodium Bisulpfite NaHSO₃:

| Parameter | L/D of 1.1 | L/D of 4.5 | L/D of 7.3 |
|---|---|---|---|
| Feed Regenerant (25 wt %) | 25 | 25 | 25 |
| NaHSO3 | | | |
| Adsorption Capacity Restored to | 92 | 93.5 | 92.4 |
| initial (%) | | | |
| Quantity of Regenerant used | 77.2 | 45.8 | 66.1 |
| (Liters) | | | |

TABLE 10
Data regeneration for Cationic Acetate Removal
Resin (Amberlyst 15) using 32 wt. % HCl

| Parameter | L/D of 1.1 | L/D of 3.5 | L/D of 4.3 | L/D of 5.5 |
|---|---|---|---|---|
| Feed Regenerant | 32 | 32 | 32 | 32 |
| (wt %) HCl | | | | |
| Adsorption Capacity | 88 | 91 | 92.7 | 89.8 |
| Restored to | | | | |
| initial (%) | | | | |
| Quantity of | 47.1 | 29.5 | 22.8 | 42.2 |
| Regenerant used | | | | |
| (Liters) | | | | |

As can be seen from Tables 9 and 10, the methods of the present invention also provide savings by reducing the quantity of regenerant needed during regeneration for each cycle.

In the context of the present invention, at least the following 13 embodiments are described. Embodiment 1 is a method of determining an optimal range for a parameter of an adsorption column. The method includes deriving an analytical solution for a chromatography and ion exchange kinetic model of the adsorption column. The method further includes deriving an analytical solution for a Linear Driving Force model, wherein each of the analytical solutions includes a mathematical correlation between a concentration of an adsorbate in the adsorption column and a feed concentration of the adsorbate. The method still further includes generating data of the concentration of the adsorbate in the adsorption column against values of a dimensionless number corresponding to the parameter based on each of the two analytical solutions. The method also includes determining the optimal range for the parameter based on the data generated by using both analytical solutions. Embodiment 2 is the method of embodiment 1, wherein the ion exchange kinetic model includes a Thomas kinetic model for chromatography and ion exchange for adsorption column. Embodiment 3 is the method of embodiment 2, wherein the analytical solution for Thomas kinetic model includes

$$\frac{c}{{c}_{0}} = \frac{{I}_{0} ( 2 \sqrt{{A}_{1} {Bx}^{′} y} ) + ϕ ( α y , β {x}^{′} )}{{I}_{0} ( 2 \sqrt{{A}_{1} {Bx}^{′} y} ) + ϕ ( α y , β {x}^{′} ) + ϕ ( B {x}^{′} , {A}_{1} y )} ,$$

where A₁ k_{d}/Q, where k_{d} is a desorption coefficient of the adsorbate on an adsorbent of the adsorption column and Q is a volumetric flowrate of a solution containing the adsorbate, B=kₐqₘ/Q, kₐ is the adsorption coefficient of the adsorbate on the adsorbent in the adsorption column, qₘ is concentration of absorbed species per unit mass of adsorbent, x′ is mass of the adsorbent at any distance from an inlet of the adsorption column, y=Qt−mx′, t is a time point, at which concentration of the adsorbate in the adsorption column is c, m is free space per mass of the adsorbent (ml/mg),

$$α = \frac{{K}_{a} {C}_{0} + {K}_{d}}{Q} , β = \frac{{K}_{a} {K}_{d} {q}_{m}}{{K}_{a} {C}_{0} + {K}_{d}} * \frac{1}{Q} ;$$

$$ϕ ( {x}^{′} , y ) = {I}_{0} ( 2 \sqrt{{A}_{1} {Bx}^{′} y} ) + \tilde{ϕ} ( {Bx}^{′} , {A}_{1} y ) + \tilde{ϕ} ( α y , β {x}^{′} ) ,$$

$$\tilde{ϕ} ( x , y ) = {e}^{x} {\int }_{0}^{x} {e}^{- t} {I}_{0} ( 2 \sqrt{yt} ) dt ; {I}_{0} ( x ) = 1 + \frac{{x}^{2}}{{2}^{2}} + \frac{{x}^{4}}{{2}^{2} {4}^{2}} + … ,$$

x is a hydrodynamic entrance length for the solution containing the adsorbate in the adsorption column. Embodiment 4 is the method of any of embodiments 1 to 3, wherein the analytical solution for Linear Driving force model includes:

$$\frac{c}{{c}_{0}} = \frac{1}{2} + A [ \frac{15 ∈ ( t - θ )}{2 \sqrt{N}} ] ,$$

where c is a concentration of an adsorbate in the adsorption column, c₀ is an initial concentration of the adsorbate, A is the area of normal curve of error; t is a time point at which the concentration of the adsorbate in the adsorption column is c, θ is the time at a point of inflection in a breakthrough curve, N is a number of theoretical equivalent plates of the adsorbent column, [symbol] =D/r², where D is a diffusion coefficient of the adsorbate in spherical particles; r is particle radius for the spherical particles. Embodiment 5 is the method of any of embodiments 1 to 4, wherein the parameter of the adsorption column includes a length of the adsorption column, a diameter of the adsorption column, a ratio of length to diameter for the adsorption column, entry length of the adsorption column, adsorbate axial distribution of the adsorption column, a flow direction for the adsorption column, wavefront development through estimation of Schmidt number and/or axial Peclet number, or combinations thereof. Embodiment 6 is the method of any of embodiments 1 to 5, wherein the parameter is a length to diameter ratio of the adsorption column, and in the optimal range of the parameter, the data generated using both analytical solutions show substantially the same trend and a adsorption efficiency related variable reaches a global maximum and/or minimum value. Embodiment 7 is the method of embodiment 6, wherein the adsorption efficiency related variable includes adsorption capacity, time of breakthrough, residence time distribution, channeling effect parameters, or combinations thereof. Embodiment 8 is the method of either of embodiments 6 or 7, wherein the determining step includes conducting multiple iterations by varying input parameters in the analytical solutions of the Thomas kinetic model and the linear driving force model. The method further includes obtaining a maximum and/or a minimum value of the adsorption efficiency related variable in a range of the parameter to be optimized. The method still further includes selecting the range for the parameter to be optimized corresponding to the maximum and/or minimum values of adsorption efficiency related variable. Embodiment 9 is the method of any of embodiments 1 to 8, wherein the adsorbate includes fluoride, urea, aldehyde, glycolic acid, acidic acid, sodium hydroxide, sodium acetate, polymeric compounds, cations, anions, or combinations thereof. Embodiment 10 is the method of any of embodiments 1 to 9, wherein the adsorbent includes activated carbon, activated alumina, silica gel, a zeolite, a polymer, a resin, or combinations thereof. Embodiment 11 is the method of embodiment 10, wherein the resin includes an anionic strongly and/or weakly basic resin, a cationic strongly and/or weakly acidic resin, a specialized ion-exchange resin, or combinations thereof. Embodiment 12 is the method of any of embodiments 1 to 11, wherein the parameter of the adsorption column is length to diameter ratio, and the optimal length to diameter ratio is in a range of 3.2 to 6.5 when the adsorption column containing an activated carbon adsorbent is used for adsorption of urea from a mixture of water dialysate containing ionic impurities. Embodiment 13 is the method of any of embodiments 1 to 12, wherein the parameter of the adsorption column is length to diameter ratio, and the optimal length to diameter ratio is in a range of 2.2 to 5.5 when the adsorption column containing an ion-exchange resin adsorbent is used for adsorption of monoethylene glycol from water containing aldehyde, mixture of glycols, acids, bases, or combinations thereof.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method of determining an optimal range for a parameter of an adsorption column, the method comprising:
deriving an analytical solution for a chromatography and ion exchange kinetic model of the adsorption column;
deriving an analytical solution for a Linear Driving Force model, wherein each of the analytical solutions includes a mathematical correlation between a concentration of an adsorbate in the adsorption column and a feed concentration of the adsorbate;
generating data of the concentration of the adsorbate in the adsorption column against values of a dimensionless number corresponding to the parameter based on each of the two analytical solutions; and
determining the optimal range for the parameter based on the data generated by using both analytical solutions.

2. The method of claim 1, wherein the ion exchange kinetic model includes a Thomas kinetic model for chromatography and ion exchange for adsorption column.

3. The method of claim 2, wherein the analytical solution for Thomas kinetic model includes:
$$\frac{c}{{c}_{0}} = \frac{{I}_{0} ( 2 \sqrt{{A}_{1} {Bx}^{′} y} ) + ϕ ( α y , β {x}^{′} )}{{I}_{0} ( 2 \sqrt{{A}_{1} {Bx}^{′} y} ) + ϕ ( α y , β {x}^{′} ) + ϕ ( B {x}^{′} {A}_{1} y )} ;$$
where A₁=k_{d}/Q, where k_{d} is a desorption coefficient of the adsorbate on an adsorbent of the adsorption column and Q is a volumetric flowrate of a solution containing the adsorbate; B=kₐqₘ/Q, kₐ is the adsorption coefficient of the adsorbate on the adsorbent in the adsorption column, q, is concentration of absorbed species per unit mass of adsorbent; x′ is mass of the adsorbent at any distance from an inlet of the adsorption column, y=Qt−mx′, t is a time point, at which concentration of the adsorbate in the adsorption column is c, m is free space per mass of the adsorbent (ml/mg)
$$a = \frac{{K}_{a} {C}_{0} + {K}_{d}}{Q} ;$$
$$β = \frac{{K}_{a} {K}_{d} {q}_{m}}{{K}_{a} {C}_{0} + {K}_{d}} * \frac{1}{Q} ;$$
$$ϕ ( {x}^{′} , y ) = {I}_{0} ( 2 \sqrt{{A}_{1} {Bx}^{′} y} ) + \tilde{ϕ} ( {Bx}^{′} , {A}_{1} y ) + \tilde{ϕ} ( α y , β {x}^{′} ) ;$$
$$\tilde{ϕ} ( x , y ) = {e}^{x} {\int }_{0}^{x} {e}^{- t} {I}_{0} ( 2 \sqrt{yt} ) dt ;$$
$${I}_{0} ( x ) = 1 + \frac{{x}^{2}}{{2}^{2}} + \frac{{x}^{4}}{{2}^{2} {4}^{2}} + … ;$$
and
x is a hydrodynamic entrance length for the solution containing the adsorbate in the adsorption column.

4. The method of claim 1, wherein the analytical solution for Linear Driving force model includes:
$$\frac{c}{{c}_{0}} = \frac{1}{2} + A [ \frac{15 ∈ ( t - θ )}{2 \sqrt{N}} ] ,$$
where c is a concentration of an adsorbate in the adsorption column; c, is an initial concentration of the adsorbate; A is the area of normal curve of error; t is a time point at which the concentration of the adsorbate in the adsorption column is c, G is the time at a point of inflection in a breakthrough curve; N is a number of theoretical equivalent plates of the adsorbent column; [symbol] =D/r², where D is a diffusion coefficient of the adsorbate in spherical particles; r is particle radius for the spherical particles.

5. The method of claim 1, wherein the parameter of the adsorption column includes a length of the adsorption column, a diameter of the adsorption column, a ratio of length to diameter for the adsorption column, entry length of the adsorption column, adsorbate axial distribution of the adsorption column, a flow direction for the adsorption column, wavefront development through estimation of Schmidt number and/or axial Peclet number, or combinations thereof.

6. The method of claim 1, wherein the parameter is a length to diameter ratio of the adsorption column, and in the optimal range of the parameter, the data generated using both analytical solutions show substantially the same trend and a adsorption efficiency related variable reaches a global maximum and/or minimum value.

7. The method of claim 6, wherein the adsorption efficiency related variable comprises adsorption capacity, time of breakthrough, residence time distribution, channeling effect parameters, or combinations thereof.

8. The method of claim 6, wherein the determining step comprises: conducting multiple iterations by varying input parameters in the analytical solutions of the Thomas kinetic model and the linear driving force model;
obtaining a maximum and/or a minimum value of the adsorption efficiency related variable in a range of the parameter to be optimized;
selecting the range for the parameter to be optimized corresponding to the maximum and/or minimum values of adsorption efficiency related variable.

9. The method of claim 1, wherein the adsorbate comprises fluoride, urea, aldehyde, glycolic acid, acidic acid, sodium hydroxide, sodium acetate, polymeric compounds, cations, anions, or combinations thereof.

10. The method of claim 1, wherein the adsorbent includes activated carbon, activated alumina, silica gel, a zeolite, a polymer, a resin, or combinations thereof.

11. The method of claim 10, wherein the resin comprises an anionic strongly and/or weakly basic resin, a cationic strongly and/or weakly acidic resin, a specialized ion-exchange resin, or combinations thereof.

12. The method of claim 1, wherein the parameter of the adsorption column is length to diameter ratio, and the optimal length to diameter ratio is in a range of 3.2 to 6.5 when the adsorption column containing an activated carbon adsorbent is used for adsorption of urea from a mixture of water dialysate containing ionic impurities.

13. The method of claim 1, wherein the parameter of the adsorption column is length to diameter ratio, and the optimal length to diameter ratio is in a range of 2.2 to 5.5 when the adsorption column containing an ion-exchange resin adsorbent is used for adsorption of monoethylene glycol from water containing aldehyde, mixture of glycols, acids, bases, or combinations thereof.

14. The method of claim 1, wherein the adsorbent includes activated carbon.

15. The method of claim 1, wherein the adsorbent includes activated alumina.

16. The method of claim 1, wherein the adsorbent includes silica gel.

17. The method of claim 1, wherein the adsorbent includes a zeolite.

18. The method of claim 1, wherein the adsorbent includes a polymer.

19. The method of claim 1, wherein the adsorbent includes a resin.

20. The method of claim 1, wherein the parameter of the adsorption column is length to diameter ratio, and the optimal length to diameter ratio is in a range of 2.2 to 5.5 when the adsorption column containing an ion-exchange resin adsorbent is used for adsorption of monoethylene glycol from water containing aldehyde.
